(19) United States
(12) Patent Application Publication
(10) Pub. No.: US 2026/0349364 A1
(43) Pub. Date: Nov. 5, 2026

(54) CHARGING ROLL FOR ELECTROPHOTOGRAPHIC DEVICES

(71) Applicant: Sumitomo Riko Company Limited, Aichi (JP)

(72) Inventors: Yoshihiro SAITO, Aichi (JP); Shimpei Miyagawa, Aichi (JP)

(73) Assignee: Sumitomo Riko Company Limited, Aichi (JP)

(21) Appl. No.: 19/731,169

(22) Filed: Jul. 6, 2026

Related U.S. Application Data
(63) Continuation of application No. PCT/JP2025/007474, filed on Mar. 3, 2025.

(30) Foreign Application Priority Data
Mar. 26, 2024 (JP) 2024-050401

(51) Int. Cl. G03G 15/02

(52) U.S. Cl. CPC G03G 15/0233

(57) ABSTRACT

Provided is a charging roll 10 for an electrophotographic device that includes: a shaft body 12, an elastic body layer 14 formed on an outer peripheral surface of the shaft body 12, and a surface layer 16 formed on an outer peripheral surface of the elastic body layer 14. The surface layer 16 contains the following (a) and (b), and a content of (b) in the surface layer 16 is 0.1 parts by mass or more and 10 parts by mass or less with respect to 100 parts by mass of (a): (a) a binder consisting of any one or two or more of isocyanurate, uretdione, carbodiimide diisocyanate, polyurea, and uretonimine, and (b) a fluorine-based anionic compound.

### CROSS-REFERENCE TO RELATED APPLICATION

The present application is a continuation of PCT/JP2025/007474, filed on Mar. 3, 2025, and is related to and claims priority from Japanese patent application no. 2024-050401, filed on Mar. 26, 2024. The entire contents of the aforementioned application are hereby incorporated by reference herein.

### BACKGROUND

### Technical Field

The present invention relates to a charging roll for an electrophotographic device that is suitably used in electrophotographic devices such as copying machines, printers, facsimiles, and the like that employ an electrophotographic system.

### Related Art

As a charging roll for an electrophotographic device, one having an elastic body layer with rubber elasticity on an outer peripheral surface of a shaft body such as a core metal and having a surface layer on an outer peripheral surface of the elastic body layer is known. In charging rolls, urethane resin may be used as a binder for the surface layer, for example, from the viewpoint of charging property.

Electrophotographic devices such as laser beam printers is required to have higher-speed printing and longer life than before due to technological advances by manufacturers and user demands. On the charging roll surface, charging and discharging processes are repeated. In the case of high-speed rotation of the photoreceptor and charging roll for high-speed printing, this process cycle cannot keep up, creating locations on the photoreceptor surface that are not discharged, resulting in black spot images. The urethane resin of the surface layer, in the case of ether-based resin, has low strength due to the influence of ether groups and is prone to crack generation during durability. Further, since there are few carbonyl groups, the capacitance is low, which is disadvantageous for chargeabilities. In the case of ester-based resin, it is prone to hydrolysis, becomes brittle over time, and is prone to crack generation. Furthermore, in the urethane resin of the surface layer, alkyl groups are prone to deterioration due to heat and ultraviolet rays generated during discharge. This causes crack generation during durability, resulting in striped image.

The present invention provides a charging roll for an electrophotographic device that may realize high chargeabilities and high durability, and may meet the demands for high-speed printing and long life.

### SUMMARY OF INVENTION

The charging roll for the electrophotographic device according to the embodiment of the present invention includes a shaft body, an elastic body layer formed on an outer peripheral surface of the shaft body, and a surface layer formed on an outer peripheral surface of the elastic body layer, in which the surface layer contains following (a) and (b), and a content of the (b) in the surface layer is 0.1 parts by mass or more and 10 parts by mass or less with respect to 100 parts by mass of the (a):
(a) a binder consisting of any one or two or more of isocyanurate, uretdione, carbodiimide diisocyanate, polyurea, and uretonimine; and
(b) a fluorine-based anionic compound.

The (b) may be a fluoroalkyl group-containing carboxylate or a fluoroalkyl group-containing sulfonate. The surface layer may include roughness-forming particles. The roughness-forming particles may be acrylic particles, urethane particles, or silica particles. The surface layer may include carbon black or a conductive metal oxide as a conductive agent. The elastic body layer may include any one or more of isoprene rubber, nitrile rubber, and hydrin rubber.
(1) The charging roll for the electrophotographic device according to the embodiment of the present invention includes a shaft body, an elastic body layer formed on an outer peripheral surface of the shaft body, and a surface layer formed on an outer peripheral surface of the elastic body layer, in which the surface layer contains following (a) and (b), and a content of the (b) in the surface layer is 0.1 parts by mass or more and 10 parts by mass or less with respect to 100 parts by mass of the (a):
(a) a binder consisting of any one or two or more of isocyanurate, uretdione, carbodiimide diisocyanate, polyurea, and uretonimine; and
(b) a fluorine-based anionic compound.
(2) In the above (1), the (b) may be a fluoroalkyl group-containing carboxylate or a fluoroalkyl group-containing sulfonate.
(3) In the above (1) or the above (2), the surface layer may include roughness-forming particles.
(4) In the above (3), the roughness-forming particles may be acrylic particles, urethane particles, or silica particles.
(5) In any one of the above (1) to the above (4), the surface layer may include carbon black or a conductive metal oxide as a conductive agent.
(6) In any one of the above (1) to the above (5), the elastic body layer may include any one or more of isoprene rubber, nitrile rubber, and hydrin rubber.

### BRIEF DESCRIPTION OF THE DRAWINGS

FIG. 1A is an appearance schematic diagram of a charging roll for an electrophotographic device according to one embodiment of the present invention, and FIG. 1B is a cross-sectional view taken along line A-A thereof.

### DESCRIPTION OF EMBODIMENTS

According to the charging roll for the electrophotographic device according to the embodiment of the present invention, by using one or two or more of isocyanurate, uretdione, carbodiimide diisocyanate, polyurea, and uretonimine as the binder of the surface layer instead of a urethane resin, and by using a specific amount of a fluorine-based anionic compound together with the binder of the surface layer, black spots do not occur in a durable image even under high-speed printing conditions, and high-speed printing may be performed with high chargeability. Further, deterioration of alkyl groups of the binder is suppressed even during durability, and long life is possible due to high durability. Since high chargeability and high durability may be realized, the charging roll for the electrophotographic device meets the demands for high-speed printing and long life.

Here, in the case of the (b) being a fluoroalkyl group-containing carboxylate or a fluoroalkyl group-containing sulfonate, it is possible to achieve a high degree of both high chargeability and high durability.

Then, in the case of the surface layer including roughness-forming particles, suitable surface irregularities are formed on the surface layer, thereby increasing the discharge space between the photoreceptor and the charging roll and promoting discharge. Thereby, the chargeability may be improved, and image defects such as horizontal stripes and unevenness may be suppressed.

Then, in the case of the roughness-forming particles being acrylic particles, urethane particles, or silica particles, the roughness-forming particles are composed of materials with high dielectric constant, thereby improving the chargeability of the roll surface.

Then, in the case of the surface layer including carbon black or a conductive metal oxide as a conductive agent, high chargeability may be maintained even during durability without occurrence of deterioration in durability due to bleed-out of the conductive agent, and the response speed that may correspond to charging and discharging processes even in high-speed printing may be exhibited.

Then, in the case of the elastic body layer including any one or more of isoprene rubber, nitrile rubber, and hydrin rubber, compression set is small, and occurrence of striped images corresponding to deformed portions during setting of the charging roll is suppressed.

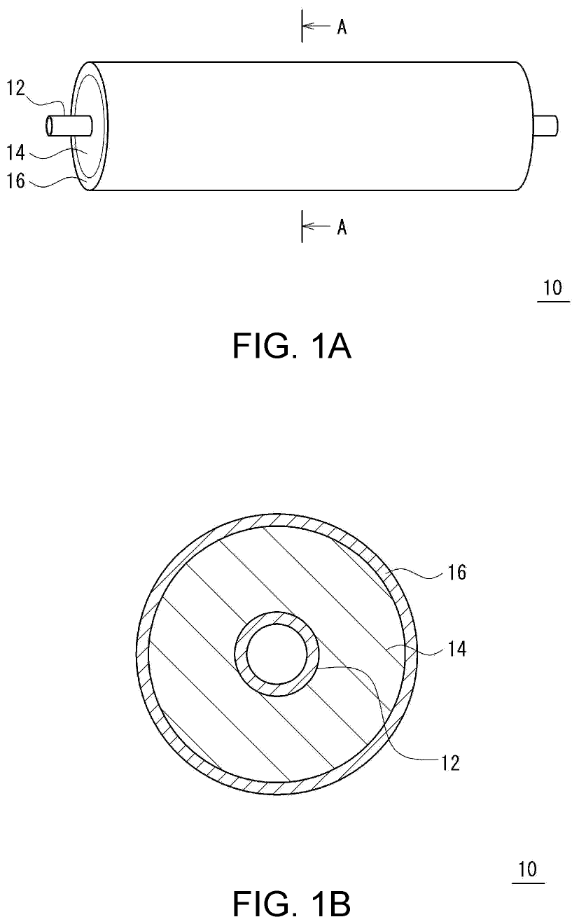

The charging roll for the electrophotographic device according to the embodiment of the present invention (hereinafter, may be simply referred to as charging roll) will be described in detail. FIG. 1A is an appearance schematic diagram of a charging roll for an electrophotographic device according to one embodiment of the present invention, and FIG. 1B is a cross-sectional view taken along line A-A thereof.

The charging roll 10 includes a shaft body 12, an elastic body layer 14 formed on an outer peripheral surface of the shaft body 12, and a surface layer 16 formed on an outer peripheral surface of the elastic body layer 14. The elastic body layer 14 is a layer (base layer) that serves as a base of the charging roll 10. The surface layer 16 is a layer that appears on a surface of the charging roll 10. Although not particularly illustrated, an intermediate layer such as a resistance adjustment layer may be formed between the elastic body layer 14 and the surface layer 16 as necessary.

The shaft body 12 is not particularly limited as long as it has conductivity. Specifically, examples of the core metal include a solid body or a hollow body made of a metal such as iron, stainless steel, or aluminum. An adhesive, primer, or the like may be applied to a surface of the shaft body 12 as necessary. That is, the elastic body layer 14 may be adhered to the shaft body 12 via an adhesive layer (primer layer). The adhesive, the primer, and the like may be made conductive as needed.

The elastic body layer 14 contains crosslinked rubber. The elastic body layer 14 is formed from a conductive rubber composition containing uncrosslinked rubber. The crosslinked rubber is obtained by crosslinking the uncrosslinked rubber. The uncrosslinked rubber may be polar rubber or non-polar rubber.

Polar rubber is rubber having polar groups, and examples of the polar groups include chloro groups, nitrile groups, carboxyl groups, epoxy groups, and the like. Specific examples of polar rubber include hydrin rubber, nitrile rubber (NBR), urethane rubber (U), acrylic rubber (copolymer of acrylic acid ester and 2-chloroethyl vinyl ether, ACM), chloroprene rubber (CR), epoxidized natural rubber (ENR), and the like. Among polar rubbers, hydrin rubber and nitrile rubber (NBR) are more preferable from the viewpoint that volume resistivity tends to be particularly low.

Examples of hydrin rubber include epichlorohydrin homopolymer (CO), epichlorohydrin-ethylene oxide binary copolymer (ECO), epichlorohydrin-allyl glycidyl ether binary copolymer (GCO), epichlorohydrin-ethylene oxide-allyl glycidyl ether terpolymer (GECO), and the like.

Examples of urethane rubber include polyether-type urethane rubber having ether bonds in the molecule. The polyether-type urethane rubber may be produced by reaction of a polyether having hydroxyl groups at two terminals with a diisocyanate. The polyether is not particularly limited, but examples include polyethylene glycol, polypropylene glycol, and the like. The diisocyanate is not particularly limited, but examples include tolylene diisocyanate, diphenylmethane diisocyanate, and the like.

Examples of non-polar rubber include silicone rubber (Q), isoprene rubber (IR), natural rubber (NR), styrene butadiene rubber (SBR), butadiene rubber (BR), and the like. Among non-polar rubbers, isoprene rubber is more preferable from the viewpoint of excellent tensile properties.

The elastic body layer 14 may contain at least one of isoprene rubber, nitrile rubber, and hydrin rubber. In the case of the elastic body layer 14 containing at least one of isoprene rubber, nitrile rubber, and hydrin rubber, compression set is small, and generation of striped images corresponding to deformed portions in response to setting of the charging roll 10 is suppressed.

Examples of crosslinking agents include sulfur crosslinking agents, peroxide crosslinking agents, and dechlorination crosslinking agents. These crosslinking agents may be used alone or in combination of two or more.

Examples of sulfur crosslinking agents include conventionally known sulfur crosslinking agents such as powder sulfur, precipitated sulfur, colloidal sulfur, surface-treated sulfur, insoluble sulfur, sulfur chloride, thiuram-based vulcanization accelerators, and polymeric polysulfides.

Examples of peroxide crosslinking agents include conventionally known peroxide crosslinking agents such as peroxy ketals, dialkyl peroxides, peroxy esters, ketone peroxides, peroxy dicarbonates, diacyl peroxides, and hydroperoxides.

Examples of dechlorination crosslinking agents include dithiocarbonate compounds. More specifically, examples include quinoxaline-2,3-dithiocarbonate, 6-methylquinoxaline-2,3-dithiocarbonate, 6-isopropylquinoxaline-2,3-dithiocarbonate, 5,8-dimethylquinoxaline-2,3-dithiocarbonate, and the like.

The blending amount of the crosslinking agent is preferably in a range of 0.1 to 2 parts by mass, more preferably in a range of 0.3 to 1.8 parts by mass, and further preferably in a range of 0.5 to 1.5 parts by mass, relative to 100 parts by mass of uncrosslinked rubber, from the viewpoint of preventing bleeding.

In the case of using a dechlorination crosslinking agent as the crosslinking agent, a dechlorination crosslinking accelerator may be used in combination. Examples of dechlorination crosslinking accelerators include 1,8-diazabicyclo(5,4,0)undecene-7 (hereinafter abbreviated as DBU) or weak acid salts thereof. The dechlorination crosslinking accelerator may be used in the form of DBU, but from the viewpoint of handling, it is preferably used in the form of weak acid salts thereof. Examples of weak acid salts of DBU include carbonate, stearate, 2-ethylhexylate, benzoate, salicylate, 3-hydroxy-2-naphthoate, phenolic resin salt, 2-mercaptobenzothiazole salt, 2-mercaptobenzimidazole salt, and the like.

The content of the dechlorination crosslinking accelerator is preferably in a range of 0.1 to 2 parts by mass relative to 100 parts by mass of uncrosslinked rubber, from the viewpoint of preventing bleeding. More preferably, it is in a range of 0.3 to 1.8 parts by mass, and further preferably in a range of 0.5 to 1.5 parts by mass.

A conductive agent may be incorporated into the elastic body layer 14 to impart conductivity. Examples of conductive agents include electronic conductive agents and ionic conductive agents. Examples of electronic conductive agents include carbon black, graphite, and conductive metal oxides. Examples of conductive metal oxides include conductive titanium oxide, conductive zinc oxide, conductive tin oxide, and the like. Examples of ionic conductive agents include quaternary ammonium salts, borates, surfactants, and the like. Further, various additives may be appropriately added to the elastic body layer 14 as necessary. Examples of additives include lubricants, vulcanization accelerators, anti-aging agents, light stabilizers, viscosity modifiers, processing aids, flame retardants, plasticizers, foaming agents, fillers, dispersants, antifoaming agents, pigments, mold release agents, and the like.

The elastic body layer 14 may be adjusted to a predetermined volume resistivity by the type of crosslinked rubber, the blending amount of ionic conductive agent, the blending amount of electronic conductive agent, and the like. The volume resistivity of the elastic body layer 14 may be appropriately set to ranges such as 10² to 10¹⁰ Ω·cm, 10³ to 10⁹ Ω·cm, or 10⁴ to 10⁸ Ω·cm according to the application and the like.

The thickness of the elastic body layer 14 is not particularly limited, and may be appropriately set within a range of 0.1 to 10 mm according to the application and the like.

The surface layer 16 contains the following (a) and (b). The binder is a base material that constitutes the surface layer 16.
(a) a binder consisting of any one or two or more of isocyanurate, uretdione, carbodiimide diisocyanate, polyurea, and uretonimine
(b) a fluorine-based anionic compound

Isocyanurate is composed of isocyanate trimers and has a 6-membered isocyanurate ring. Examples of isocyanates constituting the isocyanurate include 4,4′-diphenylmethane diisocyanate (MDI), isophorone diisocyanate (IPDI), 4,4′-dicyclohexylmethane diisocyanate (hydrogenated MDI), trimethylhexamethylene diisocyanate (TMHDI), tolylene diisocyanate (TDI), polymethylene phenyl isocyanate (PAPI), orthotoluidine diisocyanate (TODI), naphthylene diisocyanate (NDI), xylene diisocyanate (XDI), hexamethylene diisocyanate (HMDI), paraphenylene diisocyanate (PDI), lysine diisocyanate methyl ester (LDI), dimethyl diisocyanate (DDI), and the like. Among these, from the viewpoint of uniform reactivity and the like, as isocyanates constituting the isocyanurate, 4,4′-diphenylmethane diisocyanate (MDI), isophorone diisocyanate (IPDI), 4,4′-dicyclohexylmethane diisocyanate (hydrogenated MDI), trimethylhexamethylene diisocyanate (TMHDI), and tolylene diisocyanate (TDI) are more preferable.

Isocyanurate may be represented by the following general formula (1).

### [Chemical Formula 1]

In formula (1), R¹ is a divalent hydrocarbon group. Examples of the divalent hydrocarbon group include alkylene groups having 1 to 20 carbon atoms such as methylene group, 1,1-ethylene group, 1,2-ethylene group, 1,1-propylene group, 1,2-propylene group, 1,3-propylene group, 1,1-butylene group, 1,2-butylene group, 1,3-butylene group, 1,4-butylene group, 1,2-pentylene group, 1,2-hexylene group, 1,2-nonylene group, 1,2-dodecylene group; cycloalkylene groups having 3 to 20 carbon atoms such as 1,2-cyclopropylene group, 1,2-cyclobutylene group, 1,3-cyclobutylene group, 1,2-cyclopentylene group, 1,2-cyclohexylene group, 1,2-cyclononylene group, 1,2-cyclododecylene group; alkenylene groups having 2 to 20 carbon atoms such as 1,1-ethenylene group, 1,2-ethenylene group, 1,2-ethenylenemethylene group, 1-methyl-1,2-ethenylene group, 1,2-ethenylene-1,1-ethylene group, 1,2-ethenylene-1,2-ethylene group, 1,2-ethenylene-1,2-propylene group, 1,2-ethenylene-1,3-propylene group, 1,2-ethenylene-1,4-butylene group, 1,2-ethenylene-1,2-butylene group, 1,2-ethenylene-1,2-heptylene group, 1,2-ethenylene-1,2-decylene group; alkynylene groups having 2 to 20 carbon atoms such as ethynylene group, ethynylenemethylene group, ethynylene-1,1-ethylene group, ethynylene-1,2-ethylene group, ethynylene-1,2-propylene group, ethynylene-1,3-propylene group, ethynylene-1,4-butylene group, ethynylene-1,2-butylene group, ethynylene-1,2-heptylene group, ethynylene-1,2-dodecylene group; arylene groups having 6 to 20 carbon atoms such as 1,2-phenylene group, 1,3-phenylene group, 1,4-phenylene group, 1,2-naphthylene group, 1,4-naphthylene group, 1,5-naphthylene group, 2,3-naphthylene group, 2,6-naphthylene group, 3-phenyl-1,2-phenylene group, 2,2′-diphenylene group, and bifunctional hydrocarbon groups composed of arylene groups and alkylene groups having 7 to 20 carbon atoms such as 1,2-phenylenemethylene group, 1,3-phenylenemethylene group, 1,4-phenylenemethylene group, 1,2-phenylene-1,1-ethylene group, 1,2-phenylene-1,2-ethylene group, 1,2-phenylene-1,2-propylene group, 1,2-phenylene-1,3-propylene group, 1,2-phenylene-1,4-butylene group, 1,2-phenylene-1,2-butylene group, 1,2-phenylene-1,2-hexylene group, methylene-1,2-phenylenemethylene group, methylene-1,3-phenylenemethylene group, methylene-1,4-phenylenemethylene group.

In formula (1), as the divalent hydrocarbon group, alkylene groups having 1 to 20 carbon atoms and cycloalkylene groups having 3 to 20 carbon atoms are particularly preferable from the viewpoint of stability in solvents and the like.

Uretdione is composed of isocyanate dimers and has a 4-membered uretdione ring. The isocyanates constituting uretdione may be the same as those constituting the above-mentioned isocyanurate. Among these, from the viewpoint of uniform reactivity and the like, as isocyanates constituting the uretdione, 4,4′-diphenylmethane diisocyanate (MDI), isophorone diisocyanate (IPDI), 4,4′-dicyclohexylmethane diisocyanate (hydrogenated MDI), trimethylhexamethylene diisocyanate (TMHDI), and tolylene diisocyanate (TDI) are more preferable.

Uretdione may be represented by the following general formula (2).

### [Chemical Formula 2]

In formula (2), R² is a divalent hydrocarbon group, similar to R¹ of the above-mentioned isocyanurate. The divalent hydrocarbon group of uretdione may be the same as the divalent hydrocarbon group of the above-mentioned isocyanurate. In formula (2), as the divalent hydrocarbon group, similar to the above-mentioned isocyanurate, alkylene groups having 1 to 20 carbon atoms and cycloalkylene groups having 3 to 20 carbon atoms are particularly preferable. Carbodiimide diisocyanate may be represented by the following general formula (3).

### [Chemical Formula 3]

In formula (3), R³ is a divalent hydrocarbon group, similar to R¹ of the above-mentioned isocyanurate. The divalent hydrocarbon group of carbodiimide diisocyanate may be the same as the divalent hydrocarbon group of the above-mentioned isocyanurate. In formula (3), as the divalent hydrocarbon group, similar to the above-mentioned isocyanurate, alkylene groups having 1 to 20 carbon atoms and cycloalkylene groups having 3 to 20 carbon atoms are particularly preferable.

Polyurea is a polymer produced by chemical reaction between isocyanate and amine. The isocyanates constituting polyurea may be the same as those constituting the above-mentioned isocyanurate. Among these, from the viewpoint of uniform reactivity and the like, as isocyanates constituting the uretdione, 4,4′-diphenylmethane diisocyanate (MDI), isophorone diisocyanate (IPDI), 4,4′-dicyclohexylmethane diisocyanate (hydrogenated MDI), trimethylhexamethylene diisocyanate (TMHDI), and tolylene diisocyanate (TDI) are more preferable. As amines constituting polyurea, primary amines may be mentioned. As primary amines, amines having 1 to 20 carbon atoms may be mentioned. As primary amines, methylamine, ethylamine, propylamine, butylamine and the like may be mentioned.

Polyurea may be represented by the following general formula (4).

### [Chemical Formula 4]

In formula (4), R⁴ and R⁵ are the same or different monovalent hydrocarbon groups. As monovalent hydrocarbon groups, alkyl groups having 1 to 20 carbon atoms, cycloalkyl groups having 3 to 20 carbon atoms, aryl groups having 6 to 20 carbon atoms and the like may be mentioned. In formula (4), as the monovalent hydrocarbon group, alkyl groups having 1 to 20 carbon atoms are particularly preferable.

As alkyl groups, methyl group, ethyl group, n-propyl group, i-propyl group, n-butyl group, i-butyl group, sec-butyl group, t-butyl group, pentyl group, isopentyl group, neopentyl group, hexyl group, heptyl group, octyl group, 2-ethylhexyl group and the like may be mentioned. As cycloalkyl groups, cyclopentyl group, cyclohexyl group, cycloheptyl group, 2-methylcyclohexyl group and the like may be mentioned. As aryl groups, phenyl group, tolyl group, xylyl group, naphthyl group, biphenyl group and the like may be mentioned.

Uretonimine may be represented by the following general formula (5).

### [Chemical Formula 5]

In formula (5), R⁶ is a monovalent hydrocarbon group, similar to R⁴ of the above-mentioned polyurea. The monovalent hydrocarbon group of uretonimine may be the same as the monovalent hydrocarbon group of the above-mentioned polyurea. In formula (5), as the monovalent hydrocarbon group, similar to the above-mentioned polyurea, alkyl groups having 1 to 20 carbon atoms are particularly preferable.

As the binder of (a), from the viewpoint of durable stain resistance, compression set and the like, isocyanurate and uretdione are more preferable.

The binder of (a) is a main component of the binder of the surface layer 16. The binder of (a) is preferably 50% by mass or more with respect to the entire binder component of the surface layer 16. More preferably, the content is 70% by mass or more, further preferably 80% by mass or more, and particularly preferably 90% by mass or more. The binder component of the surface layer 16 is a polymer component such as polyurethane other than the binder of (a).

The binder of (a) is not polyurethane and does not have ester groups or ether groups, so there is no risk of hydrolysis caused by ester groups. Further, there is no risk of strength reduction or low dielectric constant due to ether groups. By having carbonyl groups while excluding ester groups and ether groups, strength reduction due to decomposition and the like is suppressed, and the following advantageous effects are achieved by combined use with the fluorine-based anionic compound of (b).

The fluorine-based anionic compound of (b), by being used in combination with the binder of (a), electrostatically repels the carbonyl groups of the binder of (a) while being arranged around the hydrocarbon groups of the binder of (a), so decomposition of the hydrocarbon groups of the binder of (a) caused by heat, ultraviolet rays, ozone and the like may be prevented. Thereby, decomposition of the binder of (a) is suppressed, so improvement in durability may be achieved. Further, the fluorine-based anionic compound of (b), by being anionic, electrostatically repels the carbonyl groups of the binder of (a), maintains the dipole moment of the carbonyl groups of the binder of (a), and may exhibit high dielectric properties and high chargeability. Thereby, response speed that may correspond to charging and discharging processes even in high-speed printing may be exhibited.

The fluorine-based anionic compound of (b) has an anionic group. Examples of the anionic group include carboxylate groups (—COO⁻), sulfonate groups (—SO₄²⁻), phosphate groups and the like. Among these, carboxylate groups and sulfonate groups are particularly preferable from the viewpoint of being excellent in the effect of suppressing decomposition of the hydrocarbon groups of the binder of (a) through interaction with the binder of (a), and achieving high compatibility between high chargeability and high durability.

The fluorine-based anionic compound of (b) includes a compound having an organic group containing fluorine (a compound having a fluorine-containing group). Examples of the fluorine-containing group include fluoroalkyl groups having 1 to 20 carbon atoms. The fluoroalkyl group may be a perfluoroalkyl group in which all hydrogen atoms of an alkyl group are substituted with fluorine atoms, or may be a fluoroalkyl group in which some hydrogen atoms of an alkyl group are substituted with fluorine atoms. Among these, perfluoroalkyl groups are more preferable from the viewpoint of being excellent in the effect of suppressing decomposition of the hydrocarbon groups of the binder of (a) through interaction with the binder of (a). Further, the fluorine-containing group preferably has 6 or fewer carbon atoms. More preferably 1 to 6 carbon atoms, more preferably 2 to 6 carbon atoms. In the case of the fluorine-containing group having 8 or more carbon atoms, there are strong concerns about environmental regulations, so the fluorine-containing group preferably has 6 or fewer carbon atoms. Further, in the case of the fluorine-containing group having 2 or more carbon atoms, it is preferable in that it is excellent in the function of protecting the hydrocarbon groups of the binder of (a).

The fluorine-based anionic compound of (b) may have one or more fluorine-containing groups in the molecule, but from the viewpoint of having small steric hindrance with the binder of (a) and being excellent in the function of protecting the hydrocarbon groups of the binder of (a), those having one fluorine-containing group in the molecule are particularly preferable. Further, the fluorine-based anionic compound of (b) may have one or more anionic groups in the molecule, but from the viewpoint of being excellent in interaction with the binder of (a), those having one anionic group in the molecule are particularly preferable.

The fluorine-based anionic compound of (b) may be a monomolecular body or may be a polymer. The fluorine-based anionic compound of (b) is preferably a monomolecular body rather than a polymer from the viewpoint of having small steric hindrance with the binder of (a). The molecular weight (number average molecular weight) of the fluorine-based anionic compound of (b) is preferably 400 or more from the viewpoint of stability of the interaction state and the like. More preferably, the molecular weight is 500 or more, and further more preferably 1000 or more. Further, the molecular weight (number average molecular weight) of the fluorine-based anionic compound of (b) is preferably less than 3000 from the viewpoint of the number of reactive groups. More preferably, the molecular weight is 2500 or less, and further more preferably 2000 or less.

The content of the fluorine-based anionic compound of (b) in the surface layer 16 is 0.1 parts by mass or more and 10 parts by mass or less with respect to 100 parts by mass of (a). In the case of the fluorine-based anionic compound of (b) being small in amount, the effect of suppressing decomposition of the hydrocarbon groups of the binder of (a) is low. Thereby, cracks occur during durability, and striped images occur. On the other hand, in the case of the fluorine-based anionic compound of (b) being large in amount, the effect of maintaining the dipole moment of the carbonyl groups of (a) decreases, so high chargeability may not be exhibited. Thereby, black spot images occur in the process of high-speed printing. Further, for the above reasons, the content is more preferably 0.3 parts by mass or more, further preferably 0.5 parts by mass or more. Then, for the above reasons, the content is more preferably 8 parts by mass or less, further preferably 5 parts by mass or less.

The surface layer 16 may include roughness-forming particles. The roughness-forming particles are particles for imparting roughness to the surface of the surface layer 16. That is, the particles are for imparting unevenness to the surface of the surface layer 16. The surface unevenness of the surface layer 16 increases the discharge space between the photoreceptor and the charging roll 10, and promotes discharge. Thereby, the chargeability may be improved, and image defects such as horizontal stripes and unevenness may be suppressed.

For the roughness-forming particles, resin particles, inorganic particles and the like are used. Examples of the inorganic particles include silica particles and the like. The material of the roughness-forming particles is not particularly limited. The roughness-forming particles are preferably composed of a polymer having carbonyl groups. This is because a polymer having carbonyl groups is a material with a relatively high dielectric constant, and the charging roll 10 may easily secure excellent chargeability. Further, like the binder of (a) of the surface layer 16, since carbonyl groups which are polar groups are commonly possessed, the adhesive force between the binder of (a) and the roughness-forming particles in the surface layer 16 becomes strong, and the strength is improved. Examples of the polymer having carbonyl groups include urethane resins, polyamide resins, acrylic resins, acrylic silicone resins, silicone graft acrylic polymers, acrylic graft silicone polymers, urethane rubbers and the like. Among these, urethane resins and acrylic resins are particularly preferable from the viewpoint of being excellent in dielectric constant and being excellent in adhesive force between the binder of (a) and the roughness-forming particles.

The size of the roughness-forming particles is not particularly limited, but from the viewpoint of easily securing uniform chargeability, those having an average particle diameter of 3.0 μm or more and 50 μm or less are preferable. More preferably, those having an average particle diameter of 5.0 μm or more and 30 μm or less are preferable. The average particle diameter of the roughness-forming particles is determined by observing the surface of the surface layer 16 with a laser microscope, taking the diameter of the roughness-forming particles visible during surface observation as the particle diameter, and expressing the same as an average of arbitrary 20 points.

The content of the roughness-forming particles in the surface layer 16 is not particularly limited, but from the viewpoint of easily securing uniform chargeability, it is preferably 3 parts by mass or more and 50 parts by mass or less with respect to 100 parts by mass of the binder polymer of the surface layer 16. More preferably, the content is 5 parts by mass or more and 40 parts by mass or less.

The surface layer 16 may include a conductive agent. Examples of conductive agents include electronic conductive agents and ionic conductive agents. Examples of the electronic conductive agents include carbon black, graphite, conductive metal oxides and the like. Examples of the conductive metal oxides include conductive titanium oxide, conductive zinc oxide, conductive tin oxide and the like. Examples of the ionic conductive agents include quaternary ammonium salts, quaternary phosphonium salts, imidazolium salts, borate salts, surfactants and the like.

The surface layer 16 preferably does not include an ionic conductive agent from the viewpoint of deterioration of durability due to bleed-out, reaction delay in high-speed machines and the like. Further, even in the case of the ionic conductive agent being included in the surface layer 16, it is preferably 5 parts by mass or less with respect to 100 parts by mass of the binder of (a). Further, as the conductive agent, an electronic conductive agent is preferable. Particularly, carbon black and conductive metal oxides are preferable. In the case of the surface layer 16 including carbon black or a conductive metal oxide as the conductive agent, high chargeability may be maintained even during durability without occurrence of deterioration of durability due to bleed-out of the conductive agent, and response speed capable of corresponding to charging and discharging processes even in high-speed printing may be exhibited.

The content of the electronic conductive agent in the surface layer 16 is not particularly limited, but is preferably 10 parts by mass or more and 90 parts by mass or less with respect to 100 parts by mass of the binder polymer of the surface layer 16. More preferably, it is 15 parts by mass or more and 70 parts by mass or less, and still more preferably, it is 20 parts by mass or more and 50 parts by mass or less.

To the surface layer 16, various additives may be appropriately added as necessary. Examples of the additives include plasticizers, leveling agents, fillers, vulcanization accelerators, processing aids, release agents and the like.

The volume resistivity of the surface layer 16 may be set in a semiconductive region from the viewpoint of chargeability and the like. Specifically, for example, it may be set within a range of 1.0×10⁷ to 1.0×10¹⁰ Ω·cm. The volume resistivity may be measured in accordance with JIS K6911. The thickness of the surface layer 16 is not particularly limited, and may be set in a range of 0.1 to 30 μm and the like. The thickness of the surface layer 16 may be measured by observing a cross section using a laser microscope (for example, “VK-9510” manufactured by Keyence and the like). For example, at five arbitrary positions, the distance from the surface of the elastic body layer 14 to the surface of the surface layer 16 may be respectively measured, and expressed by the average thereof.

The elastic body layer 14 may be formed, for example, as follows. First, the shaft body 12 is coaxially installed in a hollow portion of a roll molding die, an uncrosslinked conductive rubber composition is injected, and after heating and curing (crosslinking), demolding is performed, or the elastic body layer 14 is formed on the outer periphery of the shaft body 12 by extrusion molding an uncrosslinked conductive rubber composition on the surface of the shaft body 12 and the like.

The surface layer 16 may be formed by using a forming material of the surface layer 16, coating this on the outer peripheral surface of the elastic body layer 14, and appropriately performing drying treatment and the like. The forming material of the surface layer 16 may include a dilution solvent. Examples of the dilution solvent include ketone-based solvents such as methyl ethyl ketone (MEK) and methyl isobutyl ketone, alcohol-based solvents such as isopropyl alcohol (IPA), methanol and ethanol, hydrocarbon-based solvents such as hexane and toluene, acetate-based solvents such as ethyl acetate and butyl acetate, ether-based solvents such as diethyl ether and tetrahydrofuran, water and the like.

The forming material of the surface layer 16 includes the binder of (a) and the fluorine-based anionic compound of (b). The forming material of the surface layer 16 may further include roughness-forming particles as necessary. Further, it may include carbon black or a conductive metal oxide as a conductive agent. Further, it may include additives and the like that are blended as necessary.

According to the charging roll 10 having the above configuration, the binder of the surface layer 16 is changed from urethane resin to any one or two or more of isocyanurate, uretdione, carbodiimide diisocyanate, polyurea, and uretonimine, and a specific amount of a fluorine-based anionic compound is used together with the binder of the surface layer 16, so that black spots do not occur in durable images even under high-speed printing conditions, and high-speed printing is possible with high chargeability. Further, deterioration of alkyl groups of the binder is suppressed even during durability, and long life is possible due to high durability. Since high chargeability and high durability may be realized, the charging roll 10 meets the demands for high-speed printing and long life.

At this time, in the case where the elastic body layer 14 includes nitrile rubber or hydrin rubber, since nitrile rubber and hydrin rubber have polar groups, they easily attract the polar groups of the binder of (a) of the surface layer 16, and the adhesion between the elastic body layer 14 and the surface layer 16 is improved. Then, during durability, the elastic body layer 14 and the surface layer 16 become strong against shear force applied thereto, so that durability is improved. Isoprene rubber is weak against heat, and there is a possibility that part of the main chain is oxidatively decomposed during vulcanization. Then, it is considered that carbonyl groups (polar groups) are present at the oxidative decomposition sites. The generated carbonyl groups easily attract the polar groups of the binder of (a) of the surface layer 16, and even in the case where the elastic body layer 14 includes isoprene rubber, the adhesion between the elastic body layer 14 and the surface layer 16 is improved.

### EXAMPLES

Hereinafter, the present invention will be described in detail using Examples and Comparative Examples.

### Example 1

### <Preparation of Conductive Rubber Composition>

To 100 parts by mass of isoprene rubber, 30 parts by mass of carbon black, 6 parts by mass of zinc oxide, 2 parts by mass of stearic acid, 1 part by mass of sulfur, 0.5 parts by mass of a thiazole-based vulcanization accelerator, 0.5 parts by mass of a thiuram-based vulcanization accelerator, and 50 parts by mass of heavy calcium carbonate were blended, and the mixture was kneaded for 10 minutes using a closed mixer temperature-controlled to 50 °C to prepare a conductive rubber composition.

The following materials were prepared as materials for the conductive rubber composition.
Isoprene rubber (IR): “JSR IR2200” manufactured by JSR
Carbon black: “Show Black N762” manufactured by Cabot Japan
Zinc oxide: “Zinc Oxide Type 2” manufactured by Sakai Chemical Industry
Stearic acid: “Stearic Acid Sakura” manufactured by NOF Corporation
Sulfur: “Powder Sulfur” manufactured by Tsurumi Chemical Industry
Thiazole-based vulcanization accelerator: “Noxeller DM” manufactured by Ouchi Shinko Chemical Industrial
Thiuram-based vulcanization accelerator: “Noxeller TRA” manufactured by Ouchi Shinko Chemical Industrial
Heavy calcium carbonate: “Whiton B” manufactured by Shiraishi Calcium, average particle diameter 3.6 μm

### <Preparation of Elastic Body Layer>

A core metal (diameter 8 mm) was set in a molding die (pipe shape), the above composition was injected, and after heating at 180 °C for 30 minutes, cooling and demolding were performed to form an elastic body layer made of a conductive rubber elastic body having a thickness of 1.9 mm on the outer periphery of the core metal.

### <Preparation of Surface Layer Material>

To 100 parts by mass of isocyanurate, 1 part by mass of a fluorine-based anionic compound <1>, 30 parts by mass of carbon black, and 30 parts by mass of roughness-forming particles (acrylic particles) were blended, 200 parts by mass of methyl ethyl ketone (MEK) was added, and the mixture was mixed and stirred at a predetermined stirring speed to prepare a surface layer-forming composition.

### <Preparation of Surface Layer>

The surface layer-forming composition was roll-coated on the outer peripheral surface of the elastic body layer, and heat treatment was performed to form a surface layer having a thickness of 1.0 μm on the outer periphery of the elastic body layer. Thus, the charging roll of Example 1 was produced.

### Example 2

### <Preparation of Conductive Rubber Composition>

To 100 parts by mass of hydrin rubber, 5 parts by mass of a vulcanization aid, 10 parts by mass of carbon, 0.5 parts by mass of a vulcanization accelerator, 2 parts by mass of sulfur, and 50 parts by mass of a filler were added, and these were stirred and mixed by a stirrer to prepare a conductive rubber composition.

The following materials were prepared as materials for the conductive rubber composition.
Hydrin rubber (ECO, “Hydrin H1100” manufactured by Zeon Corporation)
Vulcanization aid (zinc oxide, “Zinc Oxide Type 2” manufactured by Mitsui Mining & Smelting)
Carbon (Ketjen Black EC300J manufactured by Ketjen Black International)
Vulcanization accelerator (2-mercaptobenzothiazole, “Noxeller M-P” manufactured by Ouchi Shinko Chemical Industrial Co., Ltd.)
Sulfur (“Sulfax PTC” manufactured by Tsurumi Chemical Industry Co., Ltd.)
Filler (calcium carbonate, “Hakuenka CC” manufactured by Shiraishi Kogyo Kaisha, Ltd.)

### <Preparation of Elastic Body Layer>

In the same manner as Example 1, an elastic body layer made of a conductive rubber elastic body was formed.

### <Preparation of Surface Layer Material>

To 100 parts by mass of uretdione, 1 part by mass of fluorine-based anionic compound <2>, 30 parts by mass of conductive metal oxide, and 30 parts by mass of roughness-forming particles (urethane particles) were blended, 200 parts by mass of methyl ethyl ketone (MEK) was added, and the mixture was mixed and stirred at a predetermined stirring speed to prepare a surface layer-forming composition.

### <Preparation of Surface Layer>

In the same manner as Example 1, a surface layer having a thickness of 1.0 μm was formed on the outer periphery of the elastic body layer. Thus, the charging roll of Example 2 was produced.

### Example 3

### <Preparation of Conductive Rubber Composition>

To 100 parts by mass of NBR, 0.7 parts by mass of stearic acid, 5 parts by mass of zinc oxide, 2 parts by mass of hydrotalcite, 3 parts by mass of peroxide crosslinking agent, and 20 parts by mass of carbon were blended, and these were stirred and mixed by a stirrer to prepare a conductive rubber composition.

The following materials were prepared as materials for the conductive rubber composition.
NBR: “Nipol 1041” manufactured by Zeon Corporation
Stearic acid: “Stearic Acid Sakura” manufactured by NOF Corporation
Zinc oxide: “Zinc Oxide Type 2” manufactured by Sakai Chemical Industry
Hydrotalcite: “DHT4A” manufactured by Kyowa Chemical Industry Co., Ltd.
Peroxide crosslinking agent: “Percumyl D40” manufactured by NOF Corporation
Carbon: “Ketjen Black EC300J” manufactured by Ketjen Black International

### <Preparation of Elastic Body Layer>

The heating temperature was changed to 170 °C, and an elastic body layer made of a conductive rubber elastic body was formed in the same manner as in Example 1.

### <Preparation of Surface Layer Material>

To 100 parts by mass of carbodiimide diisocyanate, 0.1 parts by mass of fluorine-based anionic compound <1>, 30 parts by mass of carbon black, and 30 parts by mass of roughness-forming particles (silica particles) were blended, 200 parts by mass of methyl ethyl ketone (MEK) was added, and the mixture was mixed and stirred at a predetermined stirring speed to prepare a surface layer-forming composition.

### <Preparation of Surface Layer>

In the same manner as Example 1, a surface layer having a thickness of 1.0 μm was formed on the outer periphery of the elastic body layer. Thus, the charging roll of Example 3 was produced.

### Example 4

### <Preparation of Conductive Rubber Composition>

To 50 parts by mass of NBR, 30 parts by mass of carbon black was blended, and these were stirred and mixed by a stirrer. Next, 50 parts by mass of isoprene rubber (IR), 5 parts by mass of peroxide crosslinking agent, 3 parts by mass of vulcanization aid, and 3 parts by mass of catalyst were blended, and these were stirred and mixed by a stirrer to prepare a conductive rubber composition.

The following materials were prepared as materials for the conductive rubber composition.
NBR: “Nipol 1041” manufactured by Zeon Corporation
IR: “Nipol IR2200” manufactured by Zeon Corporation
Carbon black: “Show Black N762” manufactured by Cabot Japan
Peroxide crosslinking agent: “Percumyl D40” manufactured by NOF Corporation
Vulcanization aid (zinc oxide, “Zinc Oxide Type 2” manufactured by Mitsui Mining & Smelting)

### <Preparation of Elastic Body Layer>

The heating temperature was changed to 180 °C, and an elastic body layer made of a conductive rubber elastic body was formed in the same manner as in Example 1.

### <Preparation of Surface Layer Material>

To 100 parts by mass of polyurea, 10 parts by mass of fluorine-based anionic compound <1>, 30 parts by mass of carbon black, and 30 parts by mass of roughness-forming particles (acrylic particles) were blended, 200 parts by mass of methyl ethyl ketone (MEK) was added, and the mixture was mixed and stirred at a predetermined stirring speed to prepare a surface layer-forming composition.

### <Preparation of Surface Layer>

In the same manner as Example 1, a surface layer having a thickness of 1.0 μm was formed on the outer periphery of the elastic body layer. Thus, the charging roll of Example 4 was produced.

### Example 5

### <Preparation of Conductive Rubber Composition>

To 50 parts by mass of NBR, 30 parts by mass of carbon black was blended, and these were stirred and mixed by a stirrer. Next, 50 parts by mass of hydrin rubber, 5 parts by mass of peroxide crosslinking agent, 3 parts by mass of vulcanization aid, and 3 parts by mass of catalyst were blended, and these were stirred and mixed by a stirrer to prepare a conductive rubber composition.

The following materials were prepared as materials for the conductive rubber composition.
NBR: “Nipol 1041” manufactured by Zeon Corporation
Hydrin rubber (ECO, “Hydrin H1100” manufactured by Zeon Corporation)
Carbon black: “Show Black N762” manufactured by Cabot Japan
Peroxide crosslinking agent: “Percumyl D40” manufactured by NOF Corporation
Vulcanization aid (zinc oxide, “Zinc Oxide Type 2” manufactured by Mitsui Mining & Smelting)

### <Preparation of Elastic Body Layer>

The heating temperature was changed to 180 °C, and an elastic body layer made of a conductive rubber elastic body was formed in the same manner as in Example 1.

### <Preparation of Surface Layer Material>

To 100 parts by mass of uretonimine, 5 parts by mass of a fluorine-based anionic compound <2>, 90 parts by mass of carbon black, and 30 parts by mass of roughness-forming particles (urethane particles) were blended, 200 parts by mass of methyl ethyl ketone (MEK) was added, and the mixture was mixed and stirred at a predetermined stirring speed to prepare a surface layer-forming composition.

### <Preparation of Surface Layer>

In the same manner as Example 1, a surface layer having a thickness of 1.0 μm was formed on the outer periphery of the elastic body layer. Thus, the charging roll of Example 5 was produced.

### Examples 6, 9, 10

A charging roll was produced in the same manner as in Example 3, except that the preparation of the surface layer material was changed as described in the table.

### Examples 7, 11

A charging roll was produced in the same manner as in Example 1, except that the preparation of the surface layer material was changed as described in the table.

### Example 8

A charging roll was produced in the same manner as in Example 2, except that the preparation of the surface layer material was changed as described in the table.

### Comparative Example 1

A charging roll was produced in the same manner as in Example 2, except that in the preparation of the surface layer material, the binder was changed to polyurethane (ether type) and blended as described in the table.

### Comparative Example 2

A charging roll was produced in the same manner as in Example 1, except that in the preparation of the surface layer material, the binder was changed to polyurethane (ester type) and blended as described in the table.

### Comparative Example 3

A charging roll was produced in the same manner as in Example 1, except that in the preparation of the surface layer material, the main binder was changed to polyurethane (ether type) and blended as described in the table.

### Comparative Example 4

A charging roll was produced in the same manner as in Example 2, except that in the preparation of the surface layer material, a fluorine-based cationic compound was used instead of the fluorine-based anionic compound and blended as described in the table.

The materials used for the surface layer material are as follows.

### (Binder)

Isocyanurate: trimer of MDI (generated by stirring MDI (Kanto Chemical Co., Inc. “10449-30”) in an oven at 180 °C for 10 hours under a quaternary ammonium salt catalyst.
Uretdione: dimer of MDI (generated by stirring MDI (Kanto Chemical Co., Inc. “10449-30”) in a 70 °C warm bath for 10 hours under a phosphine catalyst.
Carbodiimide diisocyanate: generated by stirring MDI (Kanto Chemical Co., Inc. “10449-30”) in a 60 °C warm bath for 3 hours under a phospholene catalyst.
Polyurea: generated by adding purified water to MDI (Kanto Chemical Co., Inc. “10449-30”) and stirring in a 40 °C warm bath for 3 hours.
Uretonimine: generated by adding MDI again to carbodiimide diisocyanate generated by stirring MDI (Kanto Chemical Co., Inc. “10449-30”) in a 60 °C warm bath for 3 hours under a phospholene catalyst, and stirring in a 50 °C warm bath for 3 hours.
Polyurethane (ester-based): ADEKA “ADEKA NEWACE NS-2400”
Polyurethane (ether-based): ADEKA “ADEKA POLYETHER BPX-11”

### (Additives)

Fluorine-based anionic compound <1>: carbon number 6, carboxylate, AGC Seimi Chemical “Surflon S-211”
Fluorine-based anionic compound <2>: carbon number 4, sulfonate, Kanto Chemical Co., Inc. “24041-35”
Fluorine-based anionic compound <3>: carbon number 6, sulfonate (hexafluoropropene group-containing sulfonate): NEOS “FTERGENT 110”
Fluorine-based cationic compound: perfluoroalkyl trialkyl ammonium halide, carbon number 6, ammonium salt, AGC Seimi Chemical “Surflon S-221” (Conductive agent)
Carbon black: “Show Black N762” manufactured by Cabot Japan
Conductive metal oxide: conductive tin oxide, (Ishihara Sangyo Kaisha, Ltd. “SN-100P”), average particle diameter 0.01 to 0.03 μm

### (Roughness-Forming Particles)

Acrylic particles: Sekisui Kasei Co., Ltd. “MBX-5”, average particle diameter 5 μm
Urethane particles: Negami Kogyo Co., Ltd. “Art Pearl C800 Transparent”, average particle diameter 5 μm
Silica particles: micromod “sicastar 43-00-503”, average particle diameter 5 μm

Image evaluation was performed using the produced charging roll.

### (Image Evaluation: Black Spots (Fogging))

The produced charging roll was attached to a unit of an actual machine (Konica Minolta “bizhub 750i”), and image output was performed at 25% density halftone under a 10 °C×10% RH environment, and evaluation was performed after 1 million sheet durability. Those with no black spots in the image were rated as very good “⊚”, those with several spots confirmed but within an acceptable range were rated as good “∘”, and those that were unacceptable were rated as poor “x”.

### (Image Evaluation: Cracks)

The produced charging roll was attached to a unit of an actual machine (Konica Minolta “bizhub 750i”), and image output was performed at 25% density halftone under a 10 °C×10% RH environment, and evaluation was performed after 1 million sheet durability. Those with no occurrence of striped images caused by cracks in the surface layer were rated as very good “⊚”, those with several spots confirmed but within an acceptable range were rated as good “∘”, those equivalent to current technology were rated as equivalent “Δ”, and those that were unacceptable were rated as poor “x”.

TABLE 1

| | | | Examples | | | | | |
|---|---|---|---|---|---|---|---|---|
| | | | 1 | 2 | 3 | 4 | 5 | 6 |
| Elastic body | Main material | Isoprene rubber | 100 | — | — | 50 | — | — |
| layer | | Hydrin rubber | — | 100 | — | — | 50 | — |
| | | NBR rubber | — | — | 100 | 50 | 50 | 100 |
| Surface | Binder | Isocyanurate | 100 | — | — | — | — | 30 |
| layer | | Uretdione | — | 100 | — | — | — | 30 |
| | | Carbodiimide | — | — | 100 | — | — | 30 |
| | | Polyurea | — | — | — | 100 | — | — |
| | | Uretonimine | — | — | — | — | 100 | 10 |
| | | Polyurethane ester type | — | — | — | — | — | — |
| | | Polyurethane ether type | — | — | — | — | — | — |
| | Additives | Fluorine-based anionic compound <1> carboxylate | 1 | — | 0.1 | 10 | — | 3 |
| | | Fluorine-based anionic compound <2> sulfonate | — | 1 | — | — | 5 | — |
| | | Fluorine-based anionic compound <3> sulfonate | — | — | — | — | — | — |
| | | Fluorine-based cationic compound ammonium salt | — | — | — | — | — | — |
| | Conductive agent | Carbon black | 30 | — | 30 | 30 | 90 | 10 |
| | | Conductive metal oxide | — | 30 | — | — | — | — |
| | Roughness-forming | Acrylic particle | 30 | — | — | 30 | — | — |
| | particles | Urethane particle | — | 30 | — | — | 30 | 30 |
| | | Silica particle | — | — | 30 | — | — | — |

| | | | | | | | |
|---|---|---|---|---|---|---|---|
| Evaluation | Black spot image | ⊚ | ⊚ | ⊚ | ◯ | ⊚ | ◯ |
| | Striped image | ⊚ | ⊚ | ◯ | ⊚ | ◯ | ⊚ |

| | | | Examples | | | | |
|---|---|---|---|---|---|---|---|
| | | | 7 | 8 | 9 | 10 | 11 |
| Elastic body | Main material | Isoprene rubber | 100 | — | — | — | 100 |
| layer | | Hydrin rubber | — | 100 | — | — | — |
| | | NBR rubber | — | — | 100 | 100 | — |
| Surface | Binder | Isocyanurate | 50 | 10 | 80 | 80 | 100 |
| layer | | Uretdione | 50 | — | — | — | — |
| | | Carbodiimide | — | 30 | — | — | — |
| | | Polyurea | — | 30 | — | — | — |
| | | Uretonimine | — | 30 | — | — | — |
| | | Polyurethane ester type | — | — | 20 | — | — |
| | | Polyurethane ether type | — | — | — | 20 | — |
| | Additives | Fluorine-based anionic compound <1> carboxylate | 3 | — | 3 | 3 | — |
| | | Fluorine-based anionic compound <2> sulfonate | — | 3 | — | — | — |
| | | Fluorine-based anionic compound <3> sulfonate | — | — | — | — | 3 |
| | | Fluorine-based cationic compound ammonium salt | — | — | — | — | — |
| | Conductive agent | Carbon black | — | — | 30 | 30 | 30 |
| | | Conductive metal oxide | 90 | 10 | — | — | — |
| | Roughness-forming | Acrylic particle | 30 | 30 | 15 | 15 | 30 |
| | particles | Urethane particle | — | — | 15 | 15 | — |
| | | Silica particle | — | — | — | — | — |

| | | | | | | |
|---|---|---|---|---|---|---|
| Evaluation | Black spot image | ⊚ | ◯ | ⊚ | ◯ | ⊚ |
| | Striped image | ◯ | ⊚ | ◯ | ◯ | ◯ |

TABLE 2

| | | | Comparative Example | | | |
|---|---|---|---|---|---|---|
| | | | 1 | 2 | 3 | 4 |
| Elastic body | Main material | Isoprene rubber | — | 100 | 100 | — |
| layer | | Hydrin rubber | 100 | — | — | 100 |
| | | NBR rubber | — | — | — | — |
| Surface | Binder | Isocyanurate | — | — | 10 | 30 |
| layer | | Uretdione | — | — | 10 | 30 |
| | | Carbodiimide | — | — | 10 | 30 |
| | | Polyurea | — | — | 10 | — |
| | | Uretonimine | — | — | — | 10 |
| | | Polyurethane ester type | — | 100 | — | — |
| | | Polyurethane ether type | 100 | — | 60 | — |
| | Additives | Fluorine-based anionic compound <1> sulfonate | 3 | — | — | — |
| | | Fluorine-based anionic compound <2> sulfonate | — | 3 | 3 | — |
| | | Fluorine-based anionic compound <3> sulfonate | — | — | — | — |
| | | Fluorine-based cationic compound ammonium salt | | | | 3 |
| | Conductive agent | Carbon black | 30 | 30 | 30 | 30 |
| | | Conductive metal oxide | — | — | — | — |
| | Roughness-forming | Acrylic particle | 30 | — | — | — |
| | particles | Urethane particle | — | 30 | 30 | 30 |
| | | Silica particle | — | — | — | — |

| | | | | | |
|---|---|---|---|---|---|
| Evaluation | Black spot image | X | ◯ | Δ | X |
| | Striped image | X | X | X | X |

Examples 1 to 11 use any one or two or more of isocyanurate, uretdione, carbodiimide diisocyanate, polyurea, and uretonimine as binders for the surface layer, and use fluorine-based anionic compounds together with these binders. According to Examples 1 to 11, it can be seen that black spots do not occur in durable images even under high-speed printing conditions, and high-speed printing is possible with high chargeability. Furthermore, it can be seen that deterioration of alkyl groups in the binder is suppressed even during durability, and long life is possible due to high durability.

In contrast, Comparative Example 1 uses ether-type polyurethane as the binder for the surface layer instead of the above isocyanurate and the like, and uses a fluorine-based anionic compound together with the polyurethane. According to Comparative Example 1, chargeability is insufficient under high-speed printing conditions, and the charging/discharging process may not keep up with the high-speed rotation of the charging roll, resulting in areas on the photoreceptor surface that are not discharged, causing black spot images. Thus, it is unable to cope with high-speed printing. Further, since the polyurethane binder has ether groups, it has low strength and is prone to cracking. Thus, striped images caused by cracks occur during durability. Thus, it is unable to cope with durability either. On the other hand, Comparative Example 2 uses ester-type polyurethane as the binder for the surface layer instead of the above isocyanurate and the like, and uses a fluorine-based anionic compound together with the polyurethane. In Comparative Example 2, since the polyurethane binder has ether groups, the binder is prone to hydrolysis, and striped images caused by cracks occur during durability. Thus, it may not cope with durability.

Comparative Example 3 uses ether-type polyurethane as the main material of the binder for the surface layer, and uses a fluorine-based anionic compound together with this binder. In Comparative Example 3, since the polyurethane binder has ether groups, it has low strength and is prone to cracking. Thus, striped images caused by cracks occur during durability. Thus, it may not cope with durability.

Comparative Example 4 uses any one or two or more of isocyanurate, uretdione, carbodiimide diisocyanate, polyurea, and uretonimine as binders for the surface layer, but uses a fluorine-based cationic compound instead of a fluorine-based anionic compound together with these binders. According to Comparative Example 4, the effect of maintaining the dipole moment of the carbonyl groups in the binder may not be obtained, and high chargeability may not be exhibited. Thus, chargeability is insufficient under high-speed printing conditions, and the charging/discharging process may not keep up with the high-speed rotation of the charging roll, resulting in areas on the photoreceptor surface that are not discharged, causing black spot images. Thus, it is unable to cope with high-speed printing. Furthermore, since it is difficult to arrange around the alkyl groups of the binder, the effect of suppressing deterioration of the alkyl groups in the binder is small, and deterioration of the binder occurs during durability, causing striped images due to cracks. Thus, it may not cope with durability.

Although the embodiments and examples of the present invention have been described above, the present invention is not limited to the above embodiments and examples, and various modifications are possible within a scope not departing from the gist of the present invention.

What is claimed is:

1. A charging roll for an electrophotographic device comprising a shaft body, an elastic body layer formed on an outer peripheral surface of the shaft body, and a surface layer formed on an outer peripheral surface of the elastic body layer,
wherein the surface layer contains following (a) and (b), and a content of the (b) in the surface layer is 0.1 parts by mass or more and 10 parts by mass or less with respect to 100 parts by mass of the (a), and
the surface layer contains roughness-forming particles:
(a) a binder consisting of any one or two or more of isocyanurate, uretdione, carbodiimide diisocyanate, polyurea, and uretonimine; and
(b) a fluorine-based anionic compound.

2. The charging roll for the electrophotographic device according to claim 1, wherein the (b) is a fluoroalkyl group-containing carboxylate or a fluoroalkyl group-containing sulfonate.

3. The charging roll for the electrophotographic device according to claim 1, wherein the (a) is a binder consisting of any one or two or more of isocyanurate, uretdione, polyurea, and uretonimine.

4. The charging roll for the electrophotographic device according to claim 3, wherein the roughness-forming particles are acrylic particles, urethane particles, or silica particles.

5. The charging roll for the electrophotographic device according to claim 1, wherein the surface layer contains carbon black or conductive metal oxide as a conductive agent.

6. The charging roll for the electrophotographic device according to claim 1, wherein the elastic body layer contains any one or more of isoprene rubber, nitrile rubber, and hydrin rubber.
